(19) United States
(12) Patent Application Publication
(10) Pub. No.: US 2015/0021914 A1
(43) Pub. Date: Jan. 22, 2015

(54) Apparatus and Method for Reducing Current Ripple in Double Fed Induction Wind Power Generating System

(71) Applicant: Hyosung Corporation, Seoul (KR)

(72) Inventor: Won Sang Kim, Seoul (KR)

(21) Appl. No.: 14/368,851

(22) PCT Filed: Dec. 27, 2012
(86) PCT No.: PCT/KR2012/011638

§ 371 Date: Jun. 26, 2014

(30) Foreign Application Priority Data
Dec. 27, 2011 (KR) KR10-2011-0143663

(51) Int. Cl. H02M 1/14; F03D 9/00

(52) U.S. Cl. CPC H02M 1/14; F03D 9/002
USPC 290/44

(57) ABSTRACT

The present invention relates to an apparatus and a method for reducing current ripple in a double fed induction wind power generating system. More particularly, the apparatus comprises: a ripple current sensing unit for classifying the current of a rotor of a generator into normal current and ripple current which is a current component having a frequency that is the same as the frequency of a system power source on the basis of the value obtained by slip angle-based coordinate conversion of the current of the rotor, extracting the classified ripple current, and transmitting the extracted ripple current to a ripple current control unit; and a ripple current control unit for generating a compensation voltage value on the basis of the ripple current received from the ripple current sensing unit and adding the generated compensation voltage value to a reference rotor voltage value input to a converter of a rotor side of the generator so as to reduce the current ripple generated in the current of the rotor of the generator. Thus, according to the present invention, current ripple generated in the current flowing along the rotor of a double fed induction wind power generator during a voltage drop of a system power source may be reduced, thus improving the quality of the power being supplied to the system power source.

### TECHNICAL FIELD

The present application is a national phase application of International Application PCT/KR2012/011638, filed Dec. 27, 2012, which claims priority of Korean Patent Application No. 10-2011-0143663 filed on Dec. 27, 2011, the content of each of which is hereby incorporated herein by reference in its entirety. Exemplary embodiments of the present invention relate to an apparatus and a method for reducing current ripple in a double fed induction wind power generating system, and more particularly, to an apparatus and a method for reducing a current ripple, which improve control performance of PCS (Power Converter System) in a system by reducing a ripple generated in a rotor current generated when a system voltage is dropped.

### BACKGROUND ART

Recently, in order to cope with the exhaustion of fossil fuel, a wind power generation scheme has been spotlighted as a new energy source, and in the case of a system that generates output of MW grade or more by wind power generation, a scheme using a double fed induction generator (hereinafter, referred to as ‘DFIG’) and a scheme using a permanent magnetic generator (hereinafter, referred to as ‘PMG’) are representative.

In the case of a wind power generating system using the double fed induction generator (DFIG), a stator of the generator is directly connected to the system, a rotor of the generator is connected to PCS (Power Converter System), valid power and invalid power supplied to a system power source through a rotor-side converter connected to the rotor are controlled.

In such a double fed induction generator (DFIG), a prior art (Korean Patent Application No. 2008-0021928) for improving the quality of generated power supplied to a system power source has been filed, but the present invention discloses an apparatus for reducing a current ripple generated in a rotor current when a system voltage is dropped, differently from the prior art.

### DISCLOSURE

### Technical Problem

The present invention has been made in view of the above problems, and it is an object of the present invention to provide an apparatus and a method for reducing the generation of a current ripple of a rotor in a double fed induction wind power generating system, which is generated during a voltage drop of a system power source.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with one aspect of the present invention, there is provided an apparatus for reducing a current ripple of a double fed induction wind power generating system, which includes: a ripple current sensing unit for classifying a current of a rotor of a generator into a normal current and a ripple current which is a current component having a frequency that is equal to a frequency of a system power source on the basis of a value obtained by slip angle-based coordinate conversion of the current of the rotor, extracting the classified ripple current, and transmitting the classified ripple current to a ripple current control unit (300); and the ripple current control unit for generating a compensation voltage value on the basis of the ripple current received from the ripple current sensing unit (100) and adding the generated compensation voltage value to a reference rotor voltage value input to a converter of a rotor side of the generator so as to reduce the current ripple generated in the current of the rotor of the generator.

Preferably, the ripple current sensing unit includes: a coordinate converter for receiving the current of the rotor of the generator and outputting the value obtained by the slip angle-based coordinate conversion; a band pass filter for receiving output of the coordinate converter and outputting only a value having a frequency band that is the same as the frequency of the system power source; and a ripple current extractor for coordinate-converting a value, which is output from the band pass filter, on the basis of a phase angle of the system power source and outputting the ripple current, and subtracting the value output from the band pass filter from the value output from the coordinate converter and outputting the normal current.

Preferably, the ripple current control unit includes: a second current controller for outputting a compensation voltage value for allowing the ripple current to follow a reference ripple current, which is input from an exterior, on the basis of the ripple current output from the ripple current sensing unit and the reference ripple current; and a current ripple controller for receiving the compensation voltage value, coordinate-converting the compensation voltage value on the basis of the phase angle of the rotor of the generator, and adding a result value of the coordinate conversion to the reference rotor voltage value input to a voltage modulation unit connected to the rotor-side converter of the generator.

In accordance with one aspect of the present invention, there is provided a method for reducing a current ripple of a double fed induction wind power generating system using an apparatus for reducing a current ripple, which includes: a first step of classifying a current of a rotor of a generator into a normal current and a ripple current which is a current component having a frequency that is equal to a frequency of a system power source on the basis of a value obtained by slip angle-based coordinate conversion of the current of the rotor; and a second step of adding a compensation voltage value determined on the basis of the ripple current classified in the first step to a reference rotor voltage value input to a voltage modulation unit connected to a converter of a rotor side of the generator.

Preferably, the first step includes: a 1-1 step of receiving the current of the rotor of the generator and outputting values obtained by slip angle-based coordinate conversion; a 1-2 step of allowing only a value of the values output in the 1-1 step, which has a frequency band that is equal to the frequency of the system power source, to pass; and a 1-3 step of coordinate-converting the value output in the 1-2 step on the basis of a phase angle of the system power source and outputting a ripple current.

### Advantageous Effects

According to the present invention, as compared with an existing double fed induction wind power generating system, a current ripple generated in a current of a rotor during a system voltage drop is reduced, and the quality of power supplied to a system power source is improved.

### DESCRIPTION OF DRAWINGS

The above and other objects, features and other advantages of the present invention will be more clearly understood from the following detailed description taken in conjunction with the accompanying drawings, in which:

FIG. 1 is a diagram for explaining the configuration of an apparatus for reducing a current ripple of a double fed induction wind power generating system according to the present invention;

FIG. 2 is a diagram for explaining the configuration of a ripple current sensing unit in an apparatus for reducing a current ripple of a double fed induction wind power generating system according to the present invention;

FIGS. 3a and 3b are comparison diagrams of a current ripple generated in a rotor current when an apparatus for reducing a current ripple according to the present invention is applied and is not applied; and

FIG. 4 is a diagram for explaining the flow of a method for reducing a current ripple of a double fed induction wind power generating system according to the present invention.

### BEST MODE FOR INVENTION

Hereafter, exemplary embodiments of the present invention will be described below in more detail with reference to the accompanying drawings. The terms or words used in the present specification and claims must not be limited to typical or dictionary meanings, but analyzed as meanings and concepts which coincide with the spirit of the present invention, based on the principle that the present inventor can properly define the concepts of the terms in order to describe the invention in the best way.

Thus, configurations illustrated in the embodiments and drawings of the present invention are only examples, and do not necessarily represent the spirit of the present invention. Thus, various equivalents and modifications capable of replacing the configurations may be provided at the time of filing the present application.

In the following description, PCS (Power Converter System) of a wind power generating system including an apparatus for reducing a current ripple according to the present invention includes the apparatus for reducing a current ripple according to the present invention; a control module including a first current controller and a voltage modulation unit; a rotor-side converter and a system-side converter that determine the output of the wind power generating system under the control of the control module; a DC-terminal capacitor that associates the rotor-side converter with the system-side converter; and an LCL filter that connects the system-side converter to a system power source and blocks introduction of harmonic waves to the system power source.

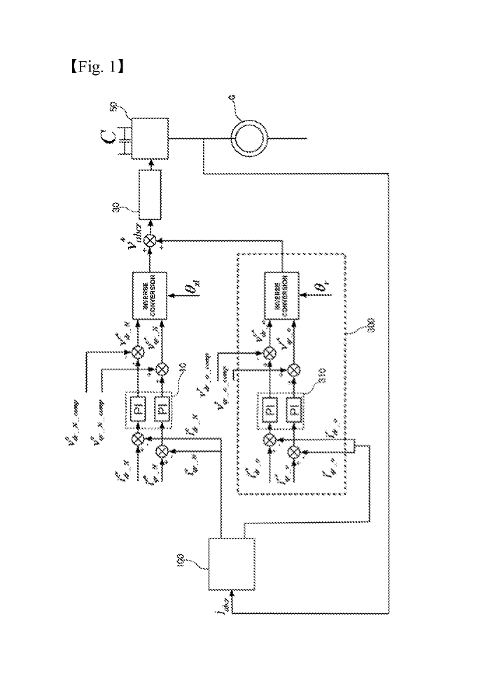

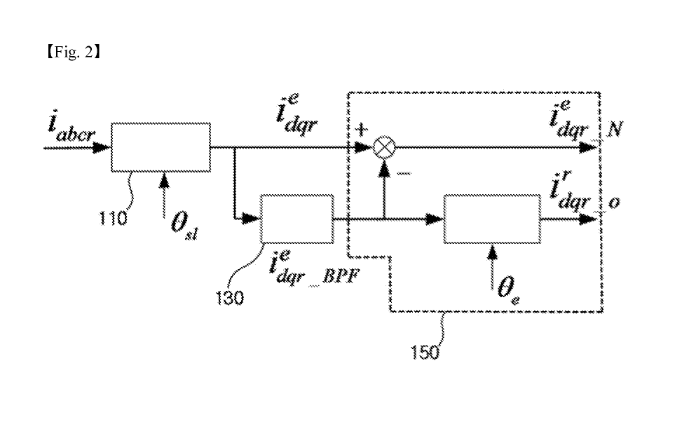

Hereinafter, the apparatus for reducing a current ripple according to the present invention will be described in detail with reference to the accompanying drawings. FIG. 1 is a diagram for explaining the configuration of the apparatus for reducing a current ripple of a double fed induction wind power generating system according to the present invention, and FIG. 2 is a diagram for explaining the configuration of a ripple current sensing unit in the apparatus for reducing a current ripple of the double fed induction wind power generating system according to the present invention.

The apparatus for reducing a current ripple according to the present invention includes a ripple current sensing unit (100) for classifying the current of a rotor of a double fed induction wind power generator (G; hereinafter, a ‘generator’) into normal current and ripple current which is a current component having a frequency that is the same as the frequency of a system voltage on the basis of the value obtained by slip angle-based coordinate conversion of the current of the rotor, extracting the classified ripple current, and transmitting the extracted ripple current to a ripple current control unit (300); the ripple current control unit (300) for generating a compensation voltage value on the basis of the ripple current received from the ripple current sensing unit (100) and adding the generated compensation voltage value to a reference rotor voltage value input to a rotor-side converter of the generator so as to reduce the current ripple generated in the current of the rotor of the generator.

The ripple current sensing unit (100) includes a coordinate converter (110) for receiving the current of the rotor of the generator and outputting the value obtained by the slip angle-based coordinate conversion, a band pass filter (130) for receiving the output of the coordinate converter (110) and outputting only a value having a frequency band that is the same as the frequency of the system voltage, and a ripple current extractor (150) for coordinate-converting a value, which is output from the band pass filter (130), on the basis of a phase angle of the system power source, outputting the ripple current, subtracting the value output from the band pass filter (130) from the value output from the coordinate converter (110), and outputting the normal current.

With reference to FIG. 2, the operation of the ripple current sensing unit (100) will be described in detail. When a rotor current (i_{abc}) flowing through the rotor of the generator G is input to the ripple current sensing unit (100), the ripple current sensing unit (100) outputs a value (i_{dqr}^{e}), which is obtained by coordinate-converting the rotor current on the basis of a slip angle (θₛₗ), through the coordinate converter (110).

At this time, the slip angle (θₛₗ) is calculated by subtracting a rotation angle (θᵣ) of the rotor from a phase angle (θₑ) of the system power source.

The value (i_{dqr}^{e}), which is output from the coordinate converter (110), is output through the band pass filter (130) as a value (i_{dqr}_{_{—}}_{BPF}^{e}) corresponding to a frequency band of the system power source connected to the generator, and the ripple current extractor (150) outputs a value, which is obtained by coordinate-converting the value (i_{dqr}_{_{—}}_{BPF}^{e}) output from the band pass filter (130) on the basis of the phase angle of the system power source, as a ripple current (i_{dqr}_{_{—}}ₒ^{r}), and outputs a normal current (i_{dqr}_{_{—}}ₙ^{e}) obtained by subtracting the value (i_{dqr}_{_{—}}_{BPF}^{e}) output from the band pass filter (130) from the value (i_{dqr}^{e}) output from the coordinate converter (110).

In addition, the normal current (i_{dqr}_{_{—}}ₙ^{e}) of the values output from the ripple current extractor (150) is input to the first current controller (10), and the ripple current (i_{dqr}_{_{—}}ₒ^{r}) of the values output from the ripple current extractor (150) is input to the ripple current control unit (300).

At this time, the ripple current (i_{dqr}_{_{—}}ₒ^{r}) is classified into a current component (i_{dr}_{_{—}}ₒ^{r}) based on a d axis and a current component (i_{qr}_{_{—}}ₒ^{r}) based on a q axis, and is input to the ripple current control unit (300). Also, the normal current (i_{dqr}_{_{—}}ₙ^{e}) is classified into a current component (i_{dr}_{_{—}}ₒ^{e}) based on the d axis and a current component (i_{qr}_{_{—}}ₒ^{e}) based on the q axis, and is input to the first current controller (10).

Then, the first current controller (10) outputs a value on the basis of the normal current (i_{dqr}_{_{—}}ₙ^{e}) input from the ripple current extractor (150), and the value output from the first current controller (10) is coordinate-converted on the basis of the slip angle (θₛₗ), and is input to a voltage modulation unit (30) connected to a rotor-side converter (50) of the generator as a reference rotor voltage value (v*_{abcr}).

The ripple current control unit (300) includes a second current controller (310) for outputting a compensation voltage value for allowing the ripple current to follow a reference ripple current on the basis of the ripple current output from the ripple current sensing unit (100) and the reference ripple current input from an exterior; and a current ripple controller (330) for receiving the compensation voltage value, coordinate-converting the compensation voltage value on the basis of the phase angle of the rotor of the generator, and adding a result value of the coordinate conversion to the reference rotor voltage value input to the voltage modulation unit (30) connected to the rotor-side converter (50) of the generator.

With reference to FIG. 1, the operation of the ripple current control unit (300) will be described in detail. As described above, the ripple current control unit (300) receives the ripple current (the d axis component i_{dr}_{_{—}}ₒ^{r} and the q axis component i_{qr}_{_{—}}ₒ^{r}) from the ripple current sensing unit 100, receives the reference ripple current (a d axis component i_{dr}_{_{—}}ₒ^{r*} and a q axis component i_{qr}_{_{—}}ₒ^{r*} input from an exterior through the second current controller 310, generates a compensation voltage value (a d axis component v_{dr}_{_{—o}}^{e*} and a q axis component v_{qr}_{_{—}}ₒ^{e*}) for allowing the ripple current to follow the reference ripple current, puts the compensation voltage value into the current ripple controller (330) to output a value obtained by coordinate conversion on the basis of the phase angle θᵣ of the rotor of the generator, and adds an output value of the current ripple controller (330) to the reference rotor voltage value (v*_{abcr}) that is a value calculated by inverse-converting the output value of the first current controller (10) by the slip angle (θₛₗ).

Furthermore, the voltage modulation unit (30) receives a value obtained by adding the output value of the current ripple controller (330) to the reference rotor voltage value (v*_{abcr}), modulates the value, and outputs the modulated value to the rotor-side converter (50).

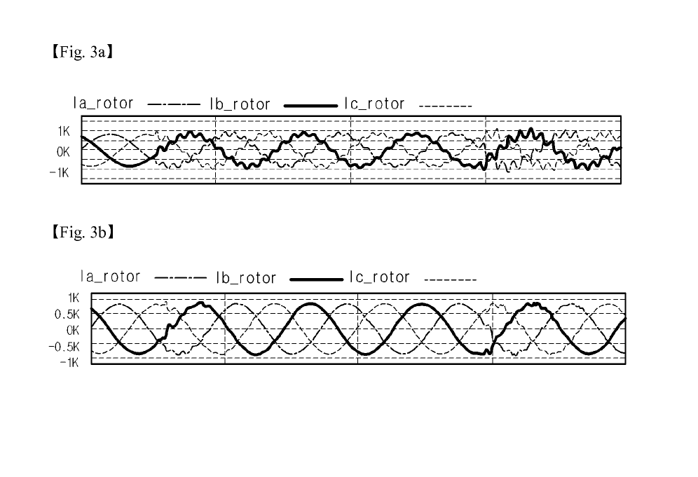

Accordingly, in the case of including and not including the apparatus for reducing a current ripple according to the present invention, results obtained by simulating the presence or absence of a current ripple of the rotor current are as illustrated in FIG. 3a and FIG. 3b, and in the case of the existing the wind power generating system, a relatively large current ripple is generated in a current by a phase of the rotor (FIG. 3a), but in the case of the wind power generating system including the apparatus for reducing a current ripple according to the present invention, a current ripple generated in a current by a phase of the rotor is relatively reduced (FIG. 3b).

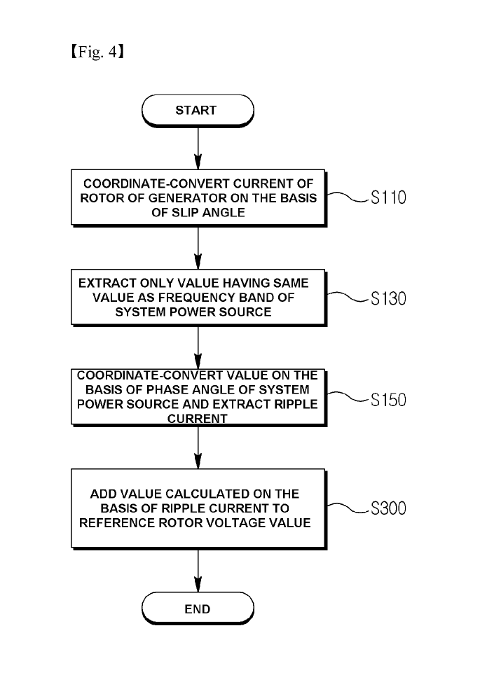

Hereinafter, the method for reducing a current ripple according to the present invention will be described in detail with reference to the accompanying drawings. FIG. 4 is a diagram for explaining the flow of the method for reducing a current ripple of the double fed induction wind power generating system according to the present invention.

The method for reducing a current ripple according to the present invention includes a first step of classifying the current of the rotor of the generator into the normal current and the ripple current which is a current component having a frequency that is the same as the frequency of the system power source on the basis of the value obtained by slip angle-based coordinate conversion of the current of the rotor; and a second step of adding a compensation voltage value determined on the basis of the ripple current classified in the first step to a reference rotor voltage value input to the voltage modulation unit connected to the rotor-side converter of the generator.

Preferably, the first step includes a 1-1 step of receiving the current of the rotor of the generator and outputting values obtained by slip angle-based coordinate-conversion; a 1-2 step of allowing only a value of the values output in the 1-1 step, which has the frequency that is the same as the frequency of the system power source, to pass, and a 1-3 step of coordinate-converting the value output in the 1-2 step on the basis of the phase angle of the system power source and outputting a ripple current.

Referring to FIG. 4, the current of the rotor of the generator is coordinate-converted on the basis of the slip angle (S110).

Next, the coordinate-converted current of the rotor of the generator is input to the band pass filter (130), and only a part having the same value as the frequency band of the system power source is extracted (S130).

Then, the value extracted in step S130 is coordinate-converted on the basis of the phase angle of the system power source, so that a ripple current is extracted (S150).

Last, a value, which is output by putting the ripple current extracted in step S150 to the current controller, is added to a reference rotor voltage value input to the rotor-side converter in the generator (S300).

While the present invention has been described with respect to the specific embodiments, it will be apparent to those skilled in the art that various changes and modifications may be made without departing from the spirit and scope of the invention as defined in the following claims.

1. An apparatus for reducing a current ripple of a double fed induction wind power generating system, comprising:
a ripple current sensing unit (100) for classifying a current of a rotor of a generator into a normal current and a ripple current which is a current component having a frequency that is equal to a frequency of a system power source on the basis of a value obtained by slip angle-based coordinate conversion of the current of the rotor, extracting the classified ripple current, and transmitting the classified ripple current to a ripple current control unit (300); and
the ripple current control unit (300) for generating a compensation voltage value on the basis of the ripple current received from the ripple current sensing unit (100) and adding the generated compensation voltage value to a reference rotor voltage value input to a converter of a rotor side of the generator so as to reduce the current ripple generated in the current of the rotor of the generator.

2. The apparatus according to claim 1, wherein the ripple current sensing unit (100) comprises:
a coordinate converter (110) for receiving the current of the rotor of the generator and outputting the value obtained by the slip angle-based coordinate conversion;
a band pass filter (130) for receiving output of the coordinate converter (110) and outputting only a value having a frequency band that is the same as the frequency of the system power source; and
a ripple current extractor (150) for coordinate-converting a value, which is output from the band pass filter (130), on the basis of a phase angle of the system power source and outputting the ripple current, and subtracting the value output from the band pass filter (130) from the value output from the coordinate converter (110) and outputting the normal current.

3. The apparatus according to claim 1, wherein the ripple current control unit (300) comprises:
a second current controller (310) for outputting a compensation voltage value for allowing the ripple current to follow a reference ripple current, which is input from an exterior, on the basis of the ripple current output from the ripple current sensing unit (100) and the reference ripple current; and
a current ripple controller (330) for receiving the compensation voltage value, coordinate-converting the compensation voltage value on the basis of the phase angle of the rotor of the generator, and adding a result value of the coordinate conversion to the reference rotor voltage value input to a voltage modulation unit connected to the rotor-side converter of the generator.

4. A method for reducing a current ripple of a double fed induction wind power generating system using an apparatus for reducing a current ripple, comprising:
a first step of classifying a current of a rotor of a generator into a normal current and a ripple current which is a current component having a frequency that is equal to a frequency of a system power source on the basis of a value obtained by slip angle-based coordinate conversion of the current of the rotor; and
a second step of adding a compensation voltage value determined on the basis of the ripple current classified in the first step to a reference rotor voltage value input to a voltage modulation unit connected to a converter of a rotor side of the generator.

5. The method according to claim 4, wherein the first step comprises:
1 a 1-1 step of receiving the current of the rotor of the generator and outputting values obtained by slip angle-based coordinate conversion;
a 1-2 step of allowing only a value of the values output in the 1-1 step, which has a frequency band that is equal to the frequency of the system power source, to pass; and
a 1-3 step of coordinate-converting the value output in the 1-2 step on the basis of a phase angle of the system power source and outputting a ripple current.
